(19) United States
(12) Patent Application Publication
(10) Pub. No.: US 2026/0044802 A1
(43) Pub. Date: Feb. 12, 2026

(54) Systems and Methods for Dynamic Task Generation for Underwriting

(71) Applicant: The PNC Financial Services Group, Inc., Pittsburgh, PA (US)

(72) Inventors: Juan J. AGOSTO, Pittsburgh, PA (US); Brandon RUFFALO, Pittsburgh, PA (US); Kelly ROPER, Pittsburgh, PA (US); Christian VanCLEEF, Pittsburgh, PA (US); Michael E. BAIRD, Pittsburgh, PA (US); Ashish GUPTA, Pittsburgh, PA (US); Matthew WEISSBERG, Pittsburgh, PA (US)

(21) Appl. No.: 19/297,451

(22) Filed: Aug. 12, 2025

Related U.S. Application Data
(60) Provisional application No. 63/682,116, filed on Aug. 12, 2024.

(51) Int. Cl. G06Q 10/0631; G06Q 40/03

(52) U.S. Cl. CPC G06Q 10/06316; G06Q 40/033

(57) ABSTRACT

Devices and methods are provided for creating, controlling, and assigning dynamic tasks for completing manual underwriting actions. Such dynamic tasks may be assigned based on received application data associated with the origination of a lending product for a customer. The tasks may be assigned to one or more parties to complete manual underwriting actions, and may be specifically configured to present application data that is tailored to the particular underwriting action associated with this task. These tasks may be created and modified using a low-code or no-code system, thereby allowing involved parties to rapidly adapt to changes in lending product regulation and new business policies.

### CROSS-REFERENCE TO RELATED APPLICATIONS

This application claims priority to U.S. Provisional Application No. 63/682,116, filed Aug. 12, 2024, the entirety of which is herein incorporated by reference.

### BACKGROUND

Financial institutions, such as a bank or credit union, provide consumers various services for managing their finances. Many of these services involve the creation, management, and retirement of accounts (e.g., credit card accounts, personal loans, mortgages, etc.) associated with a customer. For instance, loan and credit card approval processes at financial institutions typically involve a series of steps designed to assess the creditworthiness of applicants and mitigate risk for the lender. When a customer applies for a loan or credit card, they typically submit an application that includes personal, financial, and employment information. The financial institution then conducts a preliminary review involving multiple different steps to verify the accuracy of the provided information and to ensure the applicant meets basic eligibility criteria, such as minimum income requirements or residency status. This review may also involve a credit check, which can help the financial institution evaluate the applicant's credit history and score, indicating their past behavior in managing credit and debt.

Related to the lending processes of a financial institution, underwriting involves the financial institution performing a thorough evaluation of the applicant's financial situation and risk profile. Underwriters analyze various factors, including the applicant's credit score, income, debt-to-income ratio, employment stability, and other financial obligations. The goal is often to determine the likelihood that the applicant will repay the loan or credit card debt. Based on this assessment, the underwriter decides whether to approve or deny the application and, if approved, sets the terms of the loan or credit card, such as interest rates, credit limits, and repayment schedules. The underwriting process ensures that the financial institution makes informed lending decisions, balancing risk and profitability.

Based on the underwriting assessment, the financial institution may make a decision with respect to the customer application. If the application is approved, the underwriter may set the terms of the credit card, such as the credit limit and interest rate. If the application is denied, the applicant may be notified and may receive an explanation or adverse action notice detailing the reasons for denial. After activation, the customer (i.e., cardholder) can make purchases up to the predefined credit limit, and typically must manage their account by making timely payments and keeping track of their credit utilization. The financial institution may continue to monitor the account for any unusual activity or potential fraud, and may make changes to the account at the request of the customer.

### SUMMARY

The present disclosure provides devices and methods for completing manual underwriting actions through the use of an automated technique for creating, controlling, and assigning dynamic tasks. In order to improve process efficiency, the information displayed with each task may be tailored to the specific manual underwriting action. Through the automatic assignment and completion of these various tasks, manual underwriting actions may be quickly resolved by various parties associated with the underwriting process, thereby improving efficiency and accuracy. In particular, the devices and methods herein can provide tasks that include specific instructions and application data that is tailored to the particular underwriting action in a single interface. These tasks may be provided in a controlled manner to one or more parties, either simultaneously or sequentially. Moreover, systems and methods described herein may provide the ability to easily change existing underwriting tasks or add in new tasks, as needed, without needing to recode an entirely new system. As will be further described, the present disclosure therefore addresses the need to rapidly revise underwriting processes by providing a dynamic framework for task assignment that may be modified using low-code or no-code modifications. Additionally, the systems and methods described herein may utilize an underwriting engine that has access to several different information sources, thereby integrating information that may not be consistently available across disparate systems of a financial institution.

In one aspect, the present disclosure provides one or more computer storage media storing computer-readable instructions that when executed by one or more processors, cause the one or more processors to perform operations. The operations may include receiving application data associated with the origination of a lending product for a customer, and determining, based on the application data, whether a manual underwriting action is required for a decision outcome on the lending product. The operations may also include assigning a first task to a first party if a manual underwriting action is determined to be required, wherein the first task includes instructions for completing a first manual underwriting action and a determination of the application data that will be displayed to complete the first manual underwriting action. The operations may further include displaying, to the first party, instructions for completing the first manual underwriting action and the determined portion of the application data, and receiving, from the first party, a task resolution that includes information associated with a first manual underwriting action.

In another aspect, the present disclosure provides a banking system for controlling manual underwriting actions associated with the origination of a lending product. The banking system may include a datastore housing a set of underwriting task rules associated with specific underwriting tasks that will be assigned to users for completing manual underwriting actions, each underwriting task rule including information for determining when the task will be assigned to a party, instructions for completing a manual underwriting action as part of the task, and information regarding application data that will be displayed with the task. The banking system may also include one or more processors configured to perform operations including displaying, to a user, a visual interface depicting the set of underwriting task rules in a low-code or no-code form, receiving, from the user, a request to modify the set of underwriting task rules housed in the datastore, and modifying the set of underwriting task rules.

In yet another aspect, the present disclosure provides a system for controlling manual underwriting actions. The system may include means for receiving application data associated with the origination of a lending product for a customer and means for determining, based on the application data, whether a manual underwriting action is required for a decision outcome on the lending product. The system may also include means for assigning a first task to a first party if a manual underwriting action is determined to be required, wherein the first task includes instructions for completing a first manual underwriting action and a determination of the application data that will be displayed to complete the first manual underwriting action. The system may further include means for displaying, to the first party, instructions for completing the first manual underwriting action and the determined portion of the application data, and means for receiving, from the first party, a task resolution that includes information associated with a first manual underwriting action.

The current subject matter will be better understood by reference to the following detailed description when considered in combination with the accompanying drawings which form part of the present specification.

### DESCRIPTION OF DRAWINGS

FIG. 1 is a diagram depicting a banking system handling the origination of a lending product, including controlling manual underwriting actions.

FIG. 2 is a diagram depicting the generation and assignment of underwriting tasks from a workflow engine within a banking system.

FIG. 3 is a diagram depicting the integration of a workflow engine for generating underwriting tasks with various banking subsystems.

FIG. 4 is a process flowchart depicting an example method for underwriting task assignment and completion by various parties.

FIGS. 5A-5B is an example layout of an underwriting interface of a banking system handling the origination of a lending product.

FIG. 6 is a process flowchart depicting an example workflow for completing manual underwriting actions as part of an underwriting task.

FIG. 7 is a diagram depicting a task rules datastore, including underwriting task rule information stored therein.

FIG. 8A is an example layout of a left side of a user interface for modifying underwriting task rules housed within a datastore.

FIG. 8B is an example layout of a right side of a user interface for modifying underwriting task rules housed within a datastore.

FIGS. 9A-9B is a diagram depicting a set of underwriting task rules included in a table, which forms part of the user interface depicted in FIGS. 8A-8B.

FIG. 10 is a process flowchart depicting a method of controlling manual underwriting actions.

FIG. 11 is a diagram depicting an example system for implementing the approaches described herein for underwriting task control and assignment.

### DESCRIPTION

The following disclosure provides many different aspects, or examples, for implementing different features of the provided subject matter. Specific examples of components and arrangements are described below to simplify the present disclosure. These are, of course, merely examples and are not intended to be limiting.

As discussed above, the underwriting process associated with a new lending product application typically involves a financial institution evaluating an applicant's financial situation through various factors. Although some steps within the underwriting process may be automated, applications often require manual actions from various teams within a financial institution (e.g., credit verification teams, fraud prevention teams, operational support teams, etc.). Indicators with a new lending application (e.g., a new credit card application) that occur during decisioning can be referred to as “referral rules” and may require such manual actions. Examples of common referral rules might be when a credit score is too low or a debt-to-income ratio is too high. While banking systems may be configured such that some referral rules automatically lead to an application being declined, other referral rules may need to be investigated and resolved by various parties, such as operations team members, underwriters, or fraud analysts. Unfortunately, performing these manual underwriting tasks is historically an inefficient process, requiring an employee to find and follow one of numerous procedural documents, each corresponding to a different referral rule. Moreover, depending on the referral rule being worked on, the employee may be required to access various information associated with the applicant (e.g., phone number, credit history, income, age, address, customer history), and this information often needs to be accessed through dozens of different internal systems. Further complicating the process, changes in lending product regulations and new business policies occur often, which can leave the procedural documents/processes for performing the manual underwriting tasks outdated.

The present disclosure recognizes that traditional underwriting systems hinder the ability of a financial institution to process new lending product applications. Again, prior systems often rely on numerous, distinct pathways for handling the various checks that need to be performed during the origination process, and therefore are inefficient and lack cohesion, which affects customers, underwriters, auditors, and decisioning logic. The present disclosure addresses the aforementioned issues, as well as others, by providing a system for strategically creating and assigning dynamic tasks that can be accessed through a configurable underwriting UI, thereby allowing flexibility for optimization of what information needs to be displayed as well as adaption to geographical rules and practices (i.e., different application requirements in different states). Accordingly, instead of tracking down a potentially outdated procedural document to follow and taking the time to collect applicant information from various sources, parties associated with the application process can simultaneously complete manual actions through assigned tasks with relevant information for that task directly accessible. Furthermore, in order to account for rapidly changing application processes and requirements, these tasks may be created and modified using a low-code or no-code system, thereby allowing involved parties to rapidly adapt to changes in lending product regulation and new business policies.

As part of the systems and methods described herein, an underwriter interface may be used for underwriting personnel, or others, to review retail lending applications using, for example, available information on credit, customer information, and fraud and regulatory scores. The underwriter interface may draw from multiple data sources on a single interface, thereby improving efficiency, reducing errors, and bringing consistency in processing manual applications. Moreover, interface users (e.g., an underwriter at a financial institution) may have unique access and rights depending on their roles. Further still, team managers may be able to directly assign work, review progress, and generate performance reports using the underwriter interface, as will be further described.

It should be recognized that, while many examples of the present disclosure relate to example consumer credit card application processes, the systems and methods discussed herein are applicable in numerous other scenarios, including any situation were manual underwriting processes or other checks being performed by a financial institution are occurring (e.g., business credit card origination, personal loan origination, checking or saving account applications, etc.).

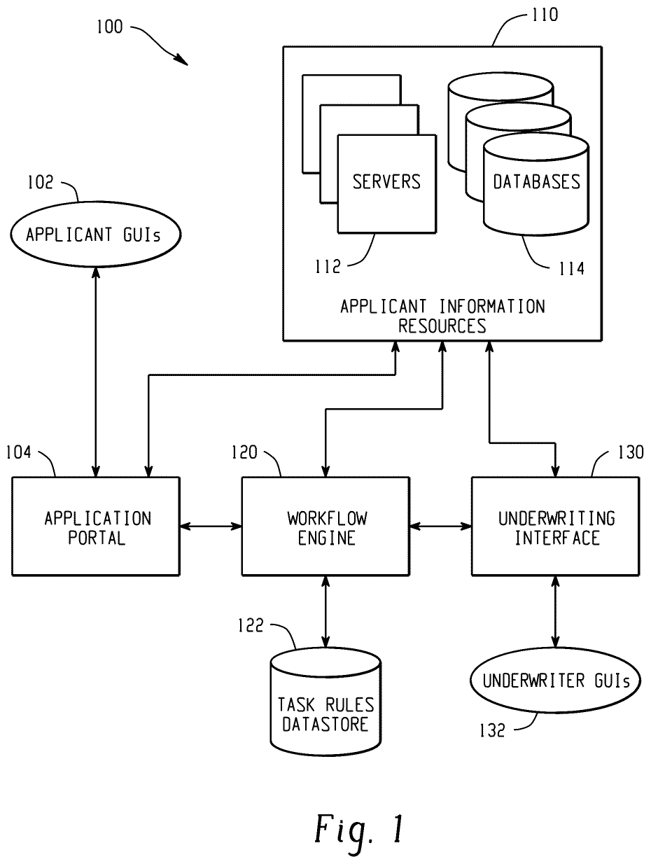

FIG. 1 depicts a banking system 100 handling the origination of a lending product for a financial institution, including controlling manual underwriting actions. As shown, one or more applicant graphical user interfaces (GUIs) 102 may be utilized by a customer or other user to access an application portal 104 associated with a lending product. In this manner, information associated with the applicant that is necessary for the underwriting and review process of the application may be received through the application portal 104. The received application data may be stored by a financial institution in one or more servers 112 or datastores 114 that collectively house applicant information resources 110. As will be further described, the applicant information resources 110 may draw information from several different sources. For instance, beyond collecting information directly from a customer via the application portal 104, the applicant information resources 110 may also include information about the customer received from credit reporting services (e.g., a FICO response), fraud protection services, publicly available resources, past customer information previously collected by the financial institution, or other information resources.

A workflow engine 120 may use the application data received from the application portal 104 as well as other data housed in the applicant information resources 110 to determine whether a manual underwriting action is required for a decision outcome (e.g., approved, denied) on the lending product application. The workflow engine 120 may rely on referral rules generated through automatic credit and fraud evaluation engines when determining whether a manual action is needed. In other words, the workflow engine may evaluate whether any referral rules apply for this particular application. If a manual underwriting action (or other manual action) is determined to be needed, the workflow engine may rely on the task rules datastore 122 to generate and assign one or more tasks to one or more parties, such that the manual underwriting actions may then be completed. As will be further described, the tasks may be presented to, for example, an employee of the financial institution using an underwriter interface 130 displayed on one or more underwriter GUIs 132. The task may be tailored to the particular referral rule and the specific underwriting actions needed. For instance, the assigned underwriting tasks may include specific instructions for completing the manual underwriting action and a determination of the application data that will be displayed to complete the first manual underwriting action. The determined data (i.e., the necessary data that an employee needs to complete the manual underwriting action) may be displayed along with the instructions on the underwriter GUIs 132. While this depiction shows the tasks being displayed on the underwriter GUIs 132, such as to an underwriter or other employee of a financial institution, in some aspects, it should also be appreciated that tasks may be generated and assigned to the application portal 104, such that an applicant or a banker may complete the tasks.

With continued reference to FIG. 1, the workflow engine 120 may then receive a task resolution that includes information associated with a first manual underwriting action from the underwriting interface 130. The task resolution may include information associated with the completion, deferral, inaction, or waiver of the one or more assigned tasks. The workflow engine 120 may use the received task resolution and reference the task rules datastore 122 to automatically generate further tasks, as needed, or make application decision outcomes.

In this manner, the banking system 100 may facilitate the generation, assignment, and completion of tasks associated with manual processes needed for a new lending application. In other words, each task may be a set of actions/steps that a human may need to take to resolve the referral rule. As one example, if a “debt to income is too high” referral rule occurs, an employee of the financial institution may receive a task instructing them to collect and verify the applicant's income by gathering pay stubs or W2 documents. Once the income information is collected and affirmed, it can be stored to the applicant information resources 110 and an application decision may be made by the workflow engine 120 based on the updated (or recalculated) debt-to-income ratio.

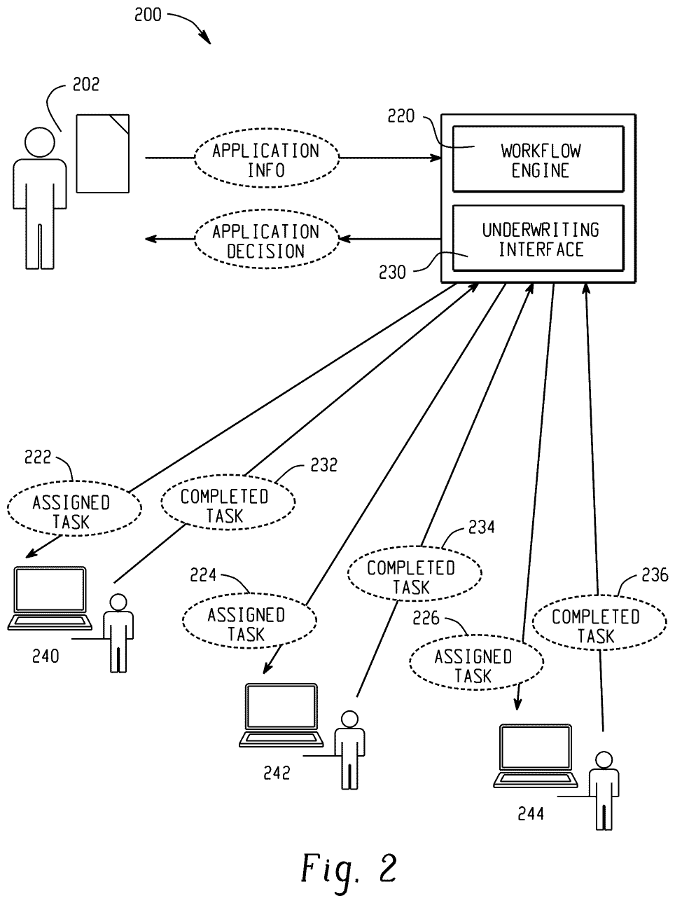

FIG. 2 depicts a diagram 200 showing the generation and assignment of underwriting tasks 222, 224, 226 from a workflow engine 220 within a banking system. As shown, application info may be collected from a customer application 202 for a new lending product and fed into a workflow engine 220 in communication with an underwriting interface platform 230. Through the underwriting interface, each assigned underwriting task 222, 224, 226 may be accessed, viewed, and completed by one or more unique parties 240, 242, 244 (e.g., underwriters, fraud support team, etc.). The completed task resolutions 232, 234, 236 may then be fed back into the workflow engine 220, which may result in additional tasks being generated or an application decision being provided to the customer, as shown.

The assigned tasks 222, 224, 226 may include instructions for completing manual underwriting actions, as well as a determination of the application data that will be displayed to complete the manual underwriting actions. Each task may be specifically tailored for the underwriting action in a variety of ways, including which instructions are provided, what relevant applicant information is accessible and/or displayed with the instructions, who the tasks are assigned and accessible to, and what order the tasks must be completed in. For example, a first party 240 may receive an assigned task 222 with displayed application data determined by the workflow engine 220 that is different from the displayed application data for a second assigned task 224.

The ordering and accessibility of the various tasks 222, 224, 226 to the various parties 240, 242, 244 may be controlled. For instance, a first task may need to be completed by a first party 240 prior to completion of a second task 242 by a second party. Alternatively, the assigned parties 240, 242, 244 may be worked on simultaneously by different parties, with each party receiving different application information through the underwriting interface 230. The ability to simultaneously access and resolve different issues requiring human action associated with each lending application may substantially improve efficiency. Moreover, access to each task 222, 224, 226 may be controlled such that all parties may not view all tasks. For example, the application data that is displayed to complete a first manual underwriting action through a first task 222 may be accessible and displayed to a first party 240, but not to other parties utilizing the underwriting interface 230. In order to facilitate this party accessibility control, each task may be categorized by department or role. For instance, each task may include a categorization identifier for either underwriting, fraud analysis, or operational support. Similarly, beyond controlling what information is visible to each party, the ability to take action to resolve each task 222, 224, 226 may be controlled as well, such that only a predetermined subset of parties may take action on each task 222, 224, 226. In this manner, some individuals may be able to view tasks 222, 224, 226 within the underwriting interface 230, but not take action on them.

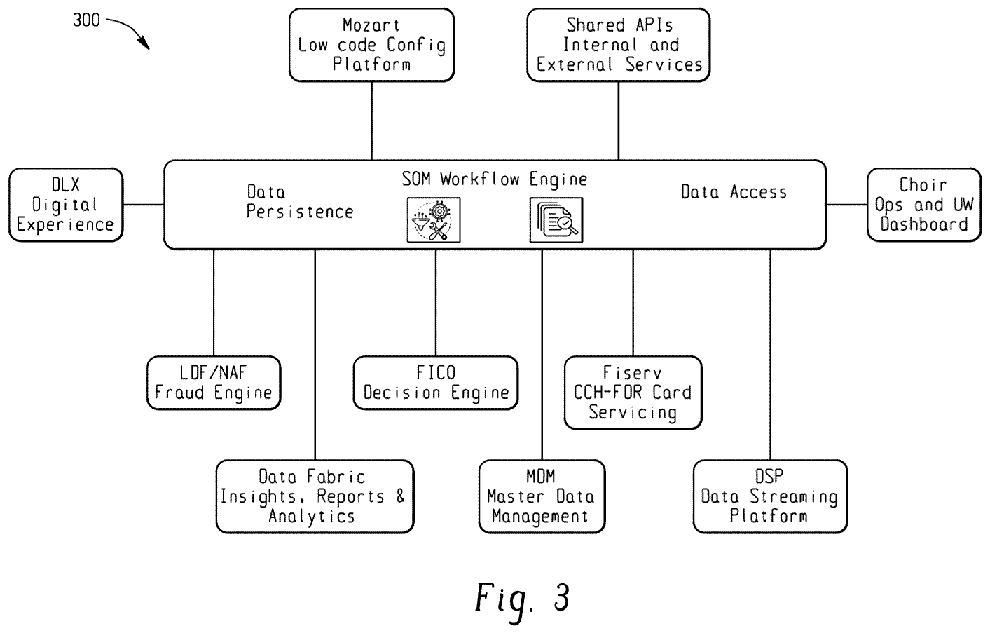

FIG. 3 depicts a diagram 300 showing the integration of an example workflow engine for generating underwriting tasks with various banking subsystems. As shown, a workflow engine (“SOM Workflow Engine”) may interact with both an application portal (“DLX Digital Experience”) and an underwriting interface (“Choir Ops and UW Dashboard”) to receive application data and present tasks for users. When determining which tasks to assign, the workflow engine may rely on a platform (“Mozart Low code Config Platform”) that references a task rules datastore to determine which tasks may be accessed by the user. The Mozart platform is described in further detail herein.

Furthermore, and as previously mentioned, the workflow engine may collect and utilize data relevant to the lending product application from several different sources beyond the information received from the applicant, including integrating information from disparate systems of the financial institution which may not be in communication with each other. Various information sources may be used, as shown (e.g., “LDF/NAF Fraud Engine,” “FICO Decision Engine,” “Fiserv CCH-FDR Card Servicing,” “Data Fabric Insights, Reports & Analytics,” “Master Data Management,” “Data Streaming Platform”). By allowing the workflow engine to connect to all the necessary data inputs, it can take input information causing an action to validate or confirm a change it has detected in the financial system.

The card servicing system, which may be facilitated by an external company (e.g., Fiserv), as shown, may function to handle issuance and servicing of a lending product (e.g., a credit card) after origination is complete. Accordingly, the workflow engine may provide necessary customer information to the card servicing system upon completion of all underwriting tasks and the origination process. The workflow engine may also receive information from card servicing system, including information that specifies which customer details to be provided upon completion of origination.

The data fabric insights, reports, and analytics system may function as a business intelligence and data science reporting system, allowing for the collection, storage, and analysis of the customer data received during the origination process, as well as the outcomes and events occurring via the workflow engine, such as the outcomes of underwriting tasks. The workflow engine may receive information from the data fabric insights, reports, and analytics system, such as customer relationship data (e.g., information on deposit balances or whether an applicant has a trust account with the financial institution), and modify the functionality of the workflow engine accordingly. For instance, if an applicant is recognized as an existing “high-value” customer of the financial institution, the workflow engine may be configured to waive certain requirements or make certain underwriting tasks optional.

The master data management system may function as a customer master record for the financial institution, housing key information (e.g., name, address, etc.) for each customer. The workflow engine may communicate with the master data management system in order to access existing customer information. For example, the workflow engine may pull information about an customer's address from the master data management system and cross-check that information with the address that has been received from the application for the new lending product. If there are discrepancies, a task may be generated, and upon clarification of the proper current address, the workflow engine may facilitate having the proper address recorded in the master data management system.

The data streaming platform may provide the continuous capture, processing, and analysis of data as it is generated by the workflow engine, enabling real-time insights and actions. For instance, the data streaming platform may receive lending application events related to the origination process (e.g., a change in a tax ID), which may then be used to trigger further action by the workflow engine (e.g., requesting a new credit pull). By keeping track of real-time events like a lending product application, the data streaming platform can identify if an actor tries to fraudulently submit multiple applications in a short period of time. The workflow engine may then use the information received from the data streaming platform to take action, such as by automatically rejecting fraudulent applications. In this manner, the workflow engine may effectively integrate with both internal and external systems to gain access to all available data that an underwriter or other employee may need to access when completing a manual review task.

The workflow engine may also specifically receive referral rules from, for example, a credit decision engine (e.g., “FICO decision engine”) or fraud decision engine (e.g., “LDF/NAF Fraud Engine”) and then reference the task rules datastore to determine which tasks need to be assigned. For example, based on credit bureau data that includes a notice of bankruptcy within the last three years and one recent late payment by the applicant, the credit engine may hold logic to automatically produce a number of referrals that require an underwriter to ask for more information from the applicant. When all the tasks are resolved, the workflow engine may be configured to set the referral rule status to either “Completed” or “Waived” and provide further information to the decision engines in order to produce a decision outcome on the application. In the instance where credit and fraud engines produce no referral rules, the workflow engine may be configured to generate no further tasks, and the lending application may be automatically approved without further review action.

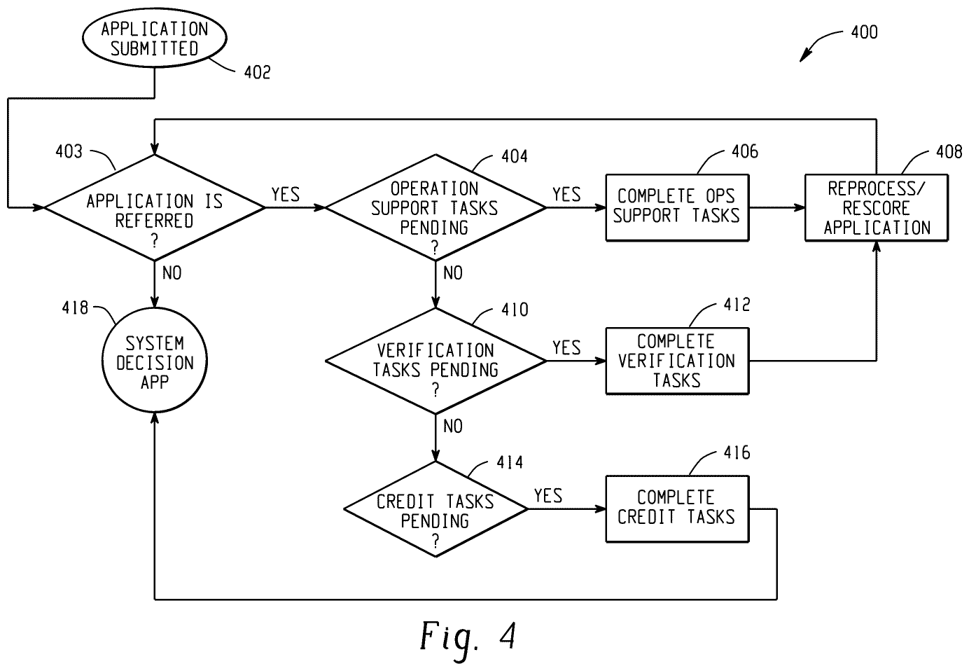

FIG. 4 depicts a process flowchart of an example method 400 for controlled underwriting task assignment and completion by various parties. In particular, the method 400 depicts the controlled assignment of tasks with a first priority given to an operational support team, a second priority given to an applicant verification team, and a third priority given to a credit evaluation team. The tasks may involve particular actions, such as calling the applicant on a phone or requiring the applicant to submit a one-time passcode. At 402 of the method 400, an applicant (e.g., customer) may submit an application for a lending product (e.g., new credit card application) that contains various application information. At 403, automated systems may initially determine whether any referral rules are associated with the application. If the application is referred and in need of one or more additional actions to address the referral rules, at 404, whether any operation support tasks are pending may be determined. If yes, at 406, a party (e.g., a member of an operational support team) may then complete the operational support tasks, such that the application may be reprocessed/rescored at 40. Operational support tasks may include underwriting or other application processing actions that do not necessarily need to be completed by an underwriter. If the application still contains original referrals, or if new referrals have been introduced, the cycle of steps 404, 406, and 408 are repeated until no referrals remain or no operational support tasks are pending.

With continued reference to FIG. 4, if no operational support tasks are pending at 404, then at 410, whether any verification tasks (i.e., fraud tasks) are pending is determined. If yes, at 412, a party (e.g., a member of an applicant verification team) may then complete the verification tasks, such that the application can be reprocessed/rescored at 408. If the application still contains original referrals, or if new referrals have been introduced, the cycle of steps 410, 412, and 408 is repeated until no referrals remain or no operational support tasks are pending. If no operational support tasks are pending at 404, and no verification tasks are pending at 410, whether any credit tasks are pending is determined at 414. These credit tasks are then completed at 416 (e.g., by a member of credit evaluation team) before the system makes an outcome decision on the application at 418. In the event that no referrals are remaining at 402, then the method may also proceed directly to the system decision application 418 without further task assignment and completion, as shown.

While FIG. 4 depicts an example of tasks being reviewed for completion by individual teams in a prioritized order, it should be appreciated that the prioritization of the tasks may be controlled using alternative techniques, depending on the organizational structure of the financial institution and the particular tasks associated with the referrals. In some aspects, tasks may be controllably assigned such that a prioritized task must be completed prior to a deprioritized task. For example, a task known to take a long period of time to complete may be given initial priority. Likewise, a task known to produce subsequent dependent tasks may be prioritized over others.

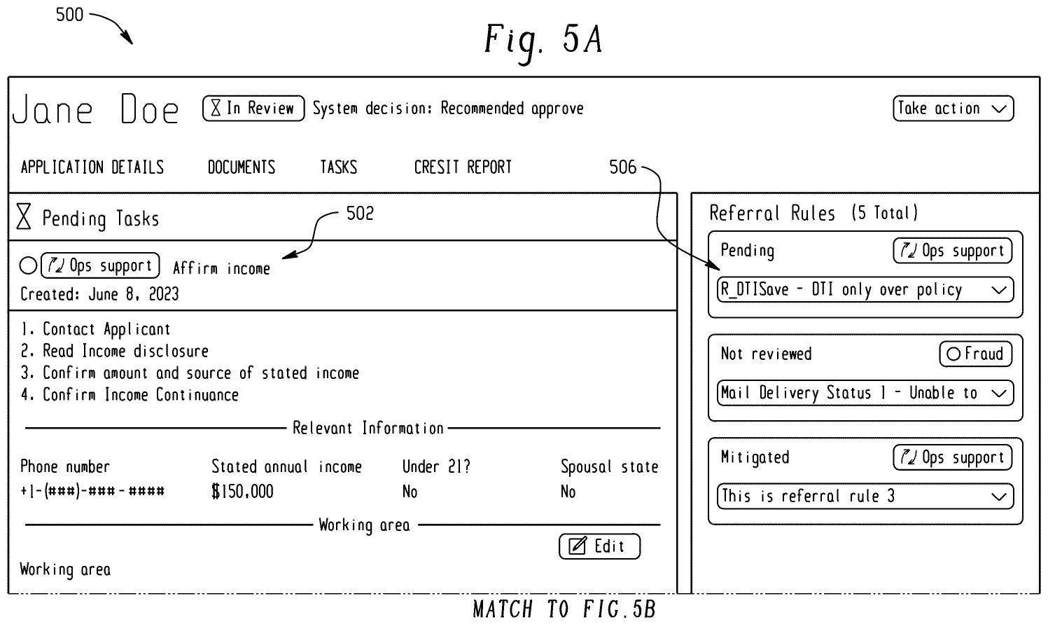

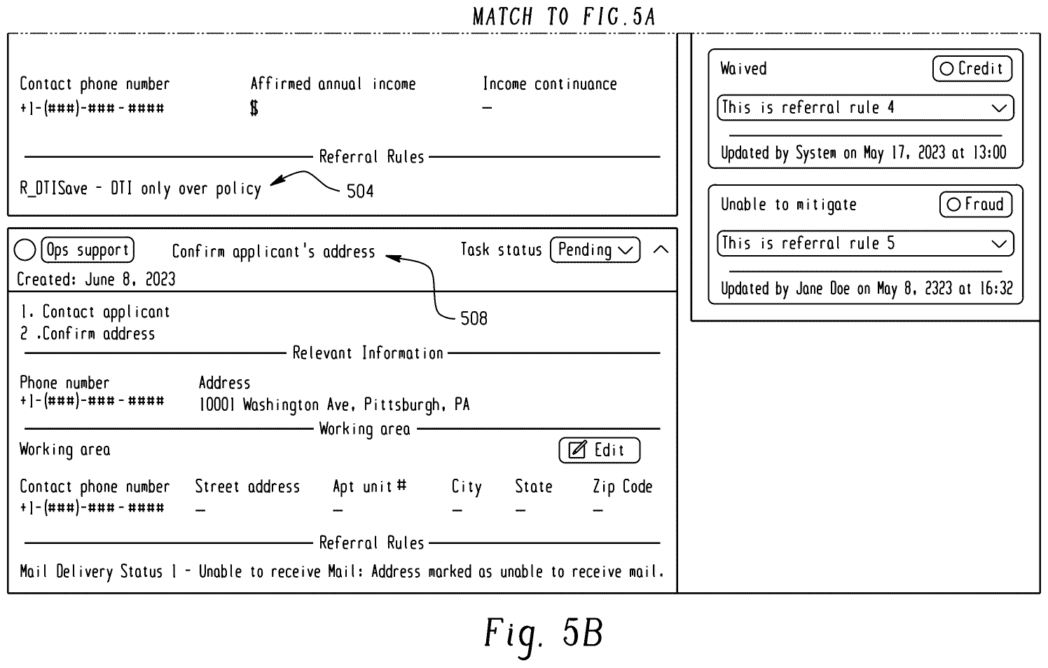

FIG. 5 depicts an example layout of an underwriting interface 500 of a banking system handling the origination of a lending product. As shown, a task 502 may need to be “completed” or “waived” by a user of the underwriting interface 500. Each task corresponds to at least one referral rule 504, and the total referral rules 506 for the application may be listed and referenced by a user. The underwriting interface 500 may draw information from applicant information resources, including information received from the applicant to present action-specific information to each user. As shown, within the underwriting interface 500, the user may have access to “Application Details,” “Documents” associated with the application, and the received “Credit Report,” which are presented as tabs in this example, as well as other application information.

Within the “Tasks” tab displayed, pending tasks for a user to take action on may be displayed in a prioritized, descending order. As shown, the example first task 502 is titled “Affirm income,” and is generated based on the referral code “R_DTISave—DTI only over policy,” which represents an issue with an applicant's debt-to-income ratio. Instructions for completing a manual underwriting action associated with the first task 502 are listed as: “1. Contact Applicant 2. Read Income Disclosure 3. Confirm amount and source of stated income 4. Confirm Income Continuance.” In this example, this task is designated “Ops support,” and is therefore intended to be completed by a user within an operational support team of a financial institution. A member of the operational team may follow these instructional steps while referencing the application data that is associated with, and particularly tailored for, this task. As shown, the relevant information for this task has been displayed to the user and includes phone numbers, stated annual incomes, the age of applicant, and their spousal status. Editable fields for “affirmed annual income” and “income continuance” are presented to the user, such that they may easily provide this information as it is received following completion of the instructions. These fields may be optionally marked as “required,” such that they need to be completed in order to mark the overall task status as complete.

Depending on the information received through the action instruction steps, the user may then adjust the “Task status” to, for example, “Completed,” “Waived,” “Pending,” “No Longer Required,” and the workflow engine may then consider the new information from the resolved task and adjust the associated referral rules status (e.g., “Pending,” “Not reviewed,” “Mitigated,” “Waived,” “Unable to Mitigate,” etc.). The workflow engine may also generate and assign dependent tasks after receiving the information associated with the task resolution, or, if all referral rules are sufficiently resolved, may generate and process an application decision outcome. The application decision outcome may include various automated processing steps, such as notifications to the applicant, generation of new lending account information, and the ultimate issuance/activation of the lending product.

As shown, each task may receive individualized application data information, which may be dynamically rendered for that specific task based on the information housed in the task rules datastore. By specifically identifying and displaying the necessary information to complete the associated action, user efficiency can be substantially improved, since the need to access pieces of information across various systems is eliminated. For instance, FIG. 5 depicts a second task 508 titled “Confirm applicant's address,” which displays different information from the first task 502. In particular, while the first task 502 includes information relative to affirming income, the second task 508 includes no information about income. Rather, the second task 508 includes information related to the instructions of contacting the applicant and confirming the address, including the applicant's address which may have been received from the credit bureau and the phone number which may have been included in the submitted application information.

It should be recognized that the underwriting interface of FIG. 5 is intended to be an example, and alternative forms may be utilized, including additional or alternative methods of organizing and displaying the tasks, referral rules, instructions, and information required to complete each task. In the event that a party assigned a task does not complete said task after a specified period of time, the workflow engine may be configured to escalate or reassign the task to a second party, such that the action can be completed and the application can continue to progress. Other time based processes can be implemented, and each assigned task may carry a creation date/time stamp.

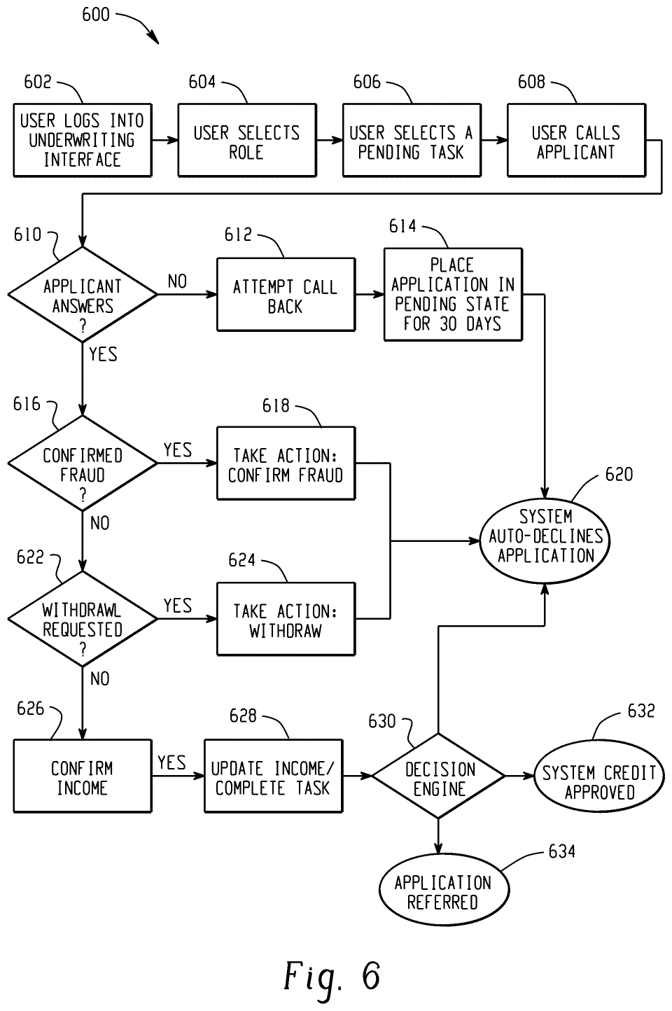

FIG. 6 is a process flowchart 600 depicting an example workflow for completing manual underwriting actions as part of an underwriting task. In this example, a user may utilize the underwriting interface described herein to complete a number of assigned tasks. At 602, a user may log into the underwriting interface, before selecting their role (e.g., operational support team member) at 604, or alternatively having a default role. Next, at 606, a user may select a pending task from an employee dashboard view, such as from a list of pending tasks assigned to them. As part of instructions associated with the task, the user may then call the applicant at 608. If the applicant does not answer at 610, then the application may be placed in a pending state before a user is instructed to call the applicant back at 612, and then return the application to a pending state for 30 days. If no applicant information is received after 30 days, at 620, the system may be configured to implement a decision outcome by auto-declining the application. This 30-day period may be configurable, and may be a shorter or longer period of time depending on applicable regulatory or legal requirements.

With continued reference to FIG. 6, if the applicant answers at 610, then, at 616, the user may follow instructions to confirm fraud. At 618, if fraud is determined to have occurred, the user may take action steps associated with confirming the fraud and the system may auto-decline the application at 620. If no fraud is found to occur at 616, whether withdrawal has been requested by the applicant may be determined at 624. If so, the system may auto-decline the application at 620. If no fraud is confirmed and no withdrawal request is made, at 626, a user may read necessary income disclosures and confirm the applicant's income. Next, at 628, the user may update the affirmed income value and mark this task as completed. At 630, the new income information may be analyzed by a decision engine. If the newly acquired income information is adequate, the system may enter a decision outcome approving the credit aspect of the lending application at 632. If the income information is inadequate, the system may enter a decision outcome declining the lending application at 620. And if the new income information triggers further referral rules, the application may again be referred such that new tasks may be assigned and completed. It should be appreciated that some portion of the steps of the method 600 may be implemented by different users of the underwriting interface.

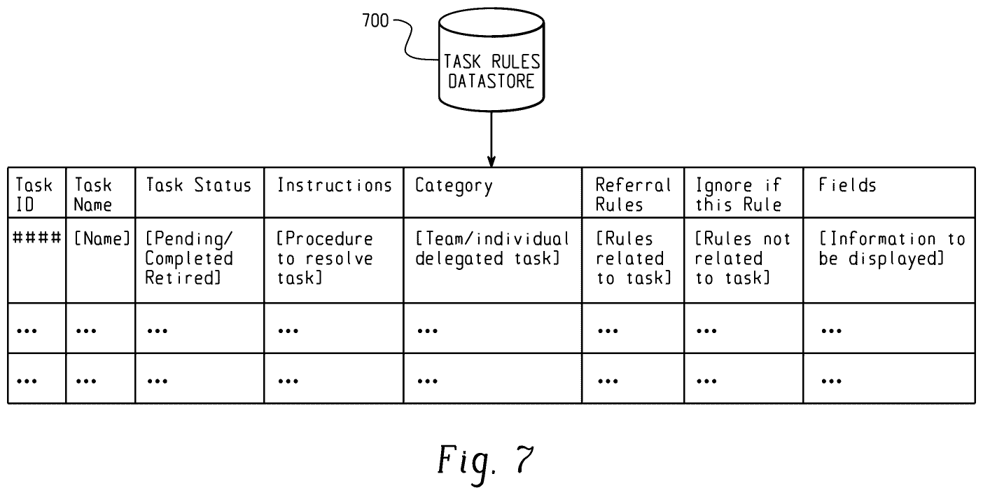

FIG. 7 is a diagram depicting a task rules datastore 700, including underwriting task rule information stored therein. The task rules datastore 700 may house information related to the assignment of tasks, including task assignment engines and task information. As will be further described, the task rules datastore may be both viewable and editable in a low-code or no-code form, such as the depicted tables in FIGS. 7-9. Advantageously, this may allow underwriters and other employees of a financial institution to directly add, edit, and remove task logic, as needed, without the need to interact with and rely on a programmer, which can take time and may lead to improper task assignment and unwanted lending decision outcomes in the interim. The task rules datastore 700 may be configured to assign and route task instructions and applicant information based on low-code or no-code fields. Given that lending product regulations (e.g., state-specific lending laws) and business (e.g., interest rates, offers, debt-to-income requirements) are often constantly changing, the present disclosure provides a dynamic and flexible system for task assignment that allows users to provide constant updates and therefore address this issue.

The task rules datastore 700 may specifically house a set of underwriting task rules associated with specific underwriting tasks that will be assigned to users for completing manual underwriting actions. As shown, each task rule may contain various information, including information for determining when the task will be assigned to a party, such as which referral rules may trigger the task, instructions for completing a manual underwriting action as part of the task, and information regarding application data that will be displayed with the task. As shown, the tasks may include additional associated information within the datastore 700, including, but not limited to, a task ID, a task name or other identifier, a task status (i.e., indicating whether the task is currently active within the workflow engine), categorization (e.g., prioritization or accessibility information), and which referral rules should not trigger the task. The workflow engine may use applicant information or referral rules to trigger particular tasks, determine the instructions and the display information associated with the task, and then assign and route the task to the appropriate party based on the information housed in the task rules datastore 700. The task rules datastore 700 may house hundreds or thousands of individual tasks, many of which may need to be frequently revised and maintained, as needed.

As discussed, the task rules datastore 700 provides flexibility through an easily editable low-code or no-code interface. For instance, one or more processors may be configured to perform various operations based on an input from a user, including displaying, to a user, a visual interface depicting the set of underwriting task rules, as shown in the examples of FIGS. 7-9. The processors may further receive, from the user, a request to modify the set of underwriting task rules housed in the datastore and then implement that request to edit the set of underwriting task rules. Again, this may include the addition, removal, or alteration of an existing task, or another change to the information housed in the task rules datastore 700. For example, if a user determines that the current task ruleset is letting through too many fraudulent applicants, then new tasks may be added or existing tasks associated with fraud analysis may be modified to prevent this undesirable outcome from reoccurring.

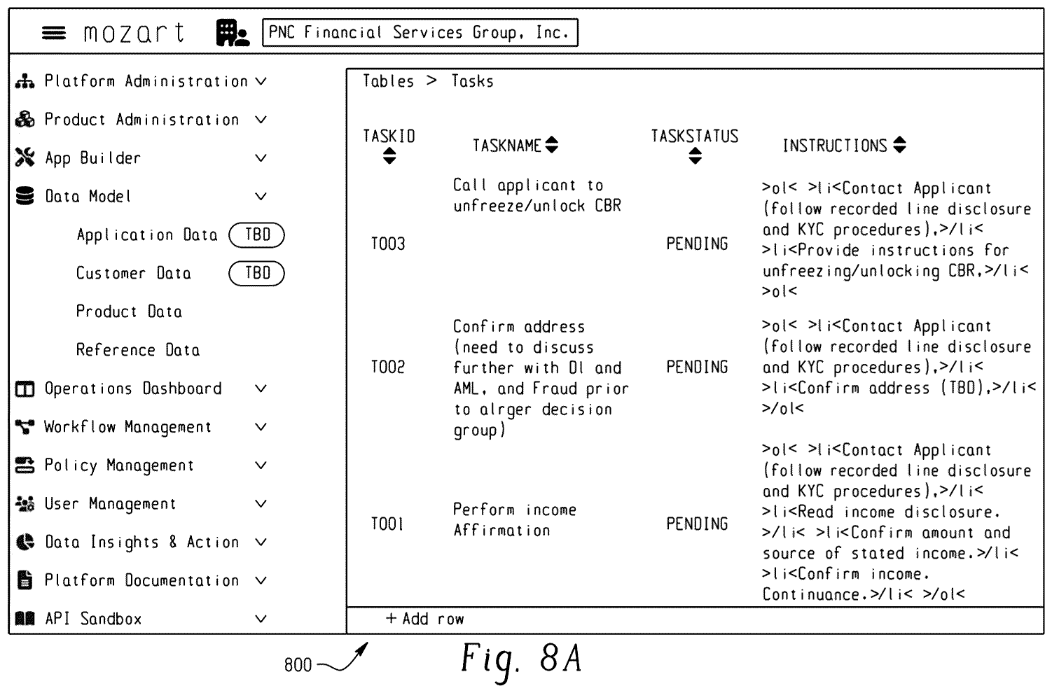

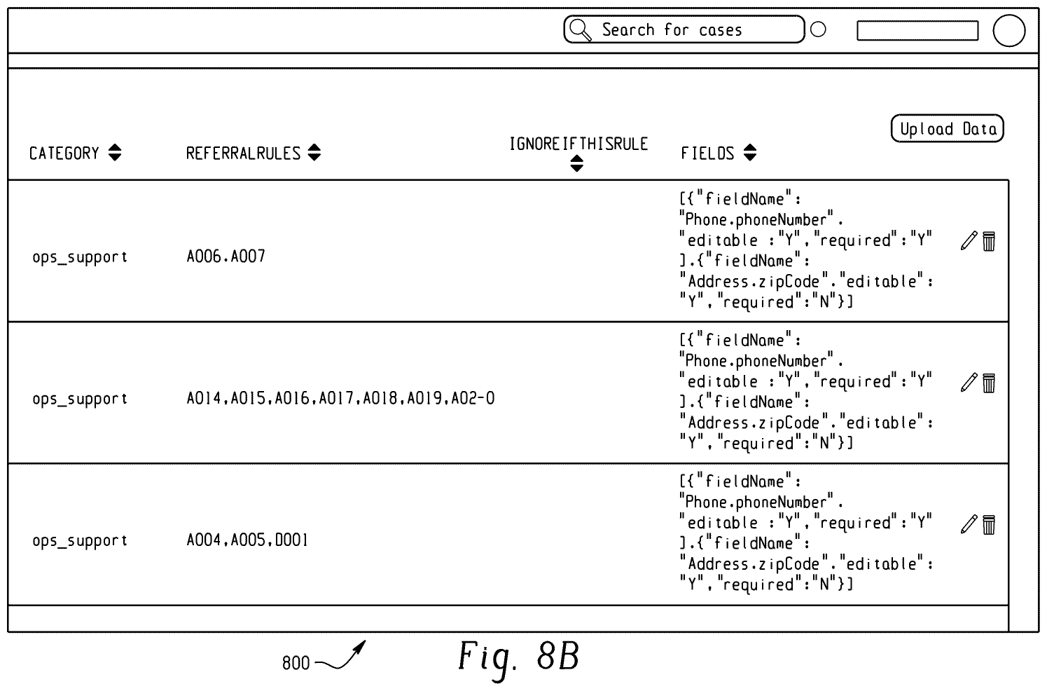

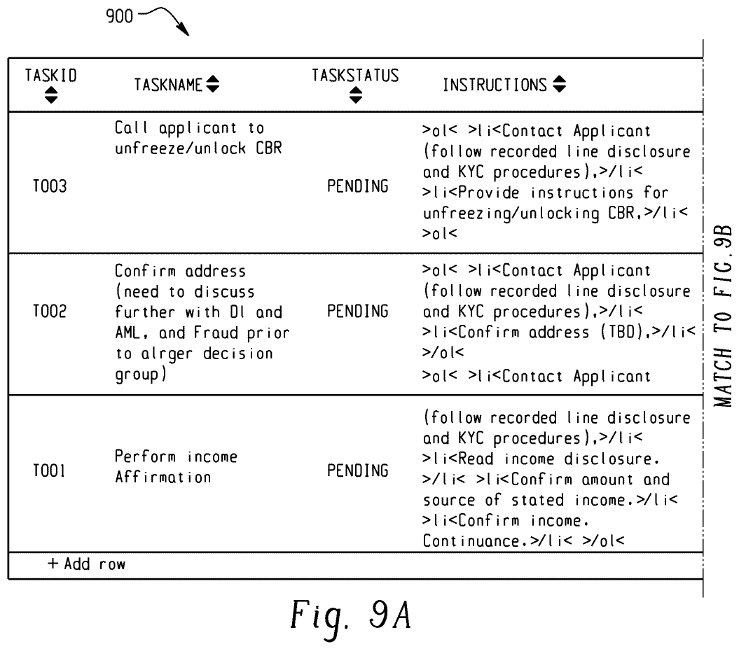

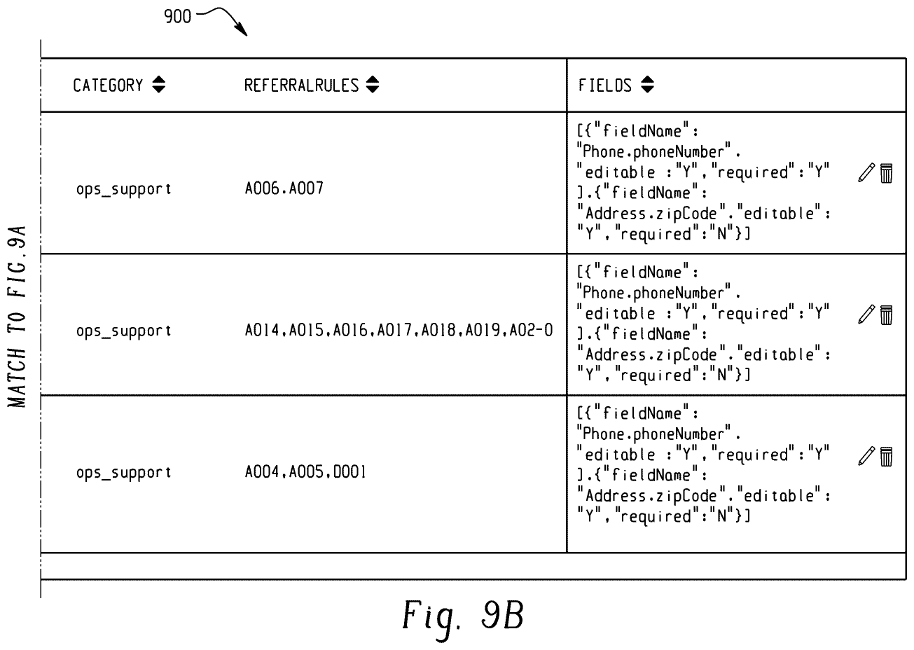

FIGS. 8A-8B depict a layout of a user interface 800 for modifying underwriting task rules housed within a datastore. As shown, the user interface may provide access to high-level application and customer data in order to make informed decisions for the associated underwriting interface and overall lending application decisioning system. A user may access the user interface 800 in order to, for example, modify an existing task, add a new task, or remove or retire existing tasks. FIG. 9 is a diagram depicting a set of underwriting task rules included in a table 900, which forms part of the user interface depicted in FIGS. 8A-8B. As shown, information associated with each task may be viewed and edited by users through a low-code system, such as an editable table, thereby improving efficiency and avoiding the need for reprogramming the system every time a task needs modification. As used herein, a “low-code” system may include systems that enable users to modify tasks with little or no hand-coding, relying instead on visual interfaces and pre-built components. Accordingly, the user interface 800 allows users to rapidly enact changes to the task assignment process without the need to provide highly technical edits in a standard programming language.

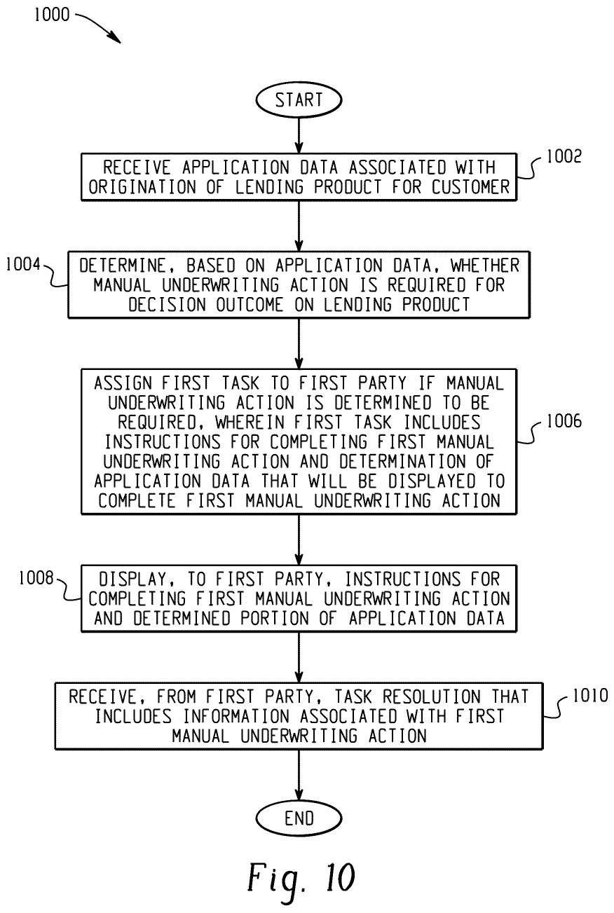

FIG. 10 is a process flowchart depicting a method 1000 of controlling manual underwriting actions, consistent with the techniques previously described herein. At 1002, application data associated with the origination of a lending product for a customer may be received. At 1004, based on the application data, whether a manual underwriting action is required for a decision outcome on the lending product may be determined. At 1006, a first task may be assigned to a first party if a manual underwriting action is determined to be required. The first task may include instructions for completing a first manual underwriting action and a determination of the application data that will be displayed to complete the first manual underwriting action. At 1008, instructions for completing the first manual underwriting action and the determined portion of the application data may be displayed to a first party. At 1010, a task resolution that includes information associated with a first manual underwriting action may be received from the first party.

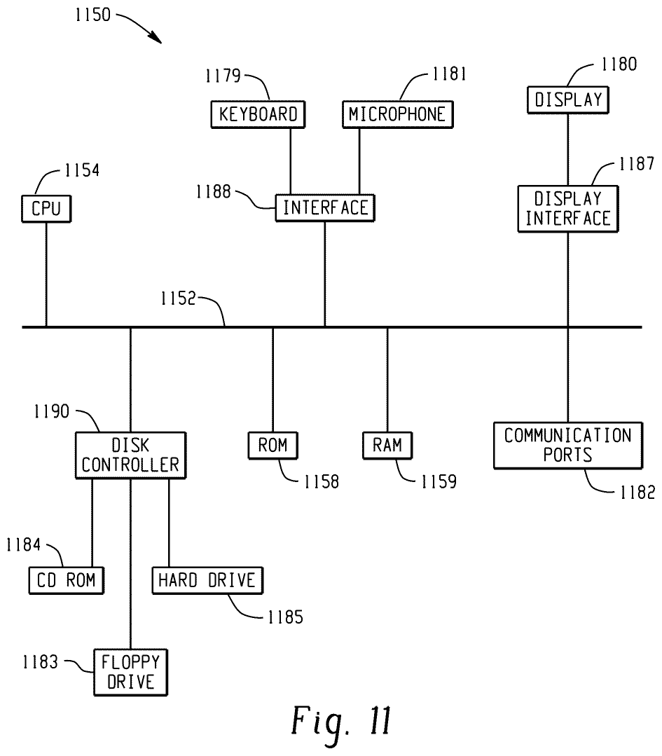

FIG. 11 shows a block diagram of exemplary hardware for a standalone computer architecture 1150 that may be used to include and/or implement the program instructions of the various aspects of the present disclosure. A bus 1152 may serve as the information highway interconnecting the other illustrated components of the hardware. A processing system 1154 labeled CPU (central processing unit) (e.g., one or more computer processors at a given computer or at multiple computers) may perform calculations and logic operations required to execute a program. A non-transitory processor-readable storage medium, such as read only memory (ROM) 1158 and random access memory (RAM) 1159, may be in communication with the processing system 1154 and may include one or more programming instructions for preventing unauthorized access to a computing system. Optionally, program instructions may be stored on a non-transitory computer-readable storage medium such as a magnetic disk, optical disk, recordable memory device, flash memory, or other physical storage medium.

In FIG. 11, computer readable memories and datastores may include one or more data structures for storing and associating various data used in the example systems. For example, a data structure stored in any of the aforementioned locations may be used to store data from XML files, initial parameters, and/or data for other variables described herein. A disk controller 1190 interfaces one or more optional disk drives to the system bus 1152. These disk drives may be external or internal floppy disk drives such as 1183, external or internal CD-ROM, CD-R, CD-RW, or DVD drives such as 1184, or external or internal hard drives 1185. As indicated previously, these various disk drives and disk controllers are optional devices. Each of the element managers, real-time data buffers, conveyors, file input processors, database indices shared access memory loader, reference data buffers, and data managers may include a software application stored in one or more of the disk drives connected to the disk controller 1190, the ROM 1158, and/or the RAM 1159. The processor 1154 may access one or more components as required.

A display interface 1187 may permit information from the bus 1152 to be displayed on a display 1180 in audio, graphic, or alphanumeric format. Communication with external devices may optionally occur using various communication ports 1182. In addition to these computer-type components, the hardware may also include data input devices, such as a keyboard 1179, or other input device 1181, such as a microphone, remote control, pointer, mouse, and/or joystick.

Generally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, or JAVA, for example, or any other suitable programming language. Other implementations may also be used, however, such as firmware or even appropriately designed hardware configured to carry out the methods and systems described herein.

The present disclosure has been presented for purposes of illustration. It is not exhaustive and is not limited to precise forms or embodiments disclosed. Modifications and adaptations of the embodiments will be apparent from consideration of the specification and practice of the disclosed embodiments. Moreover, while illustrative embodiments have been described herein, the scope includes any and all embodiments having equivalent elements, modifications, omissions, combinations (e.g., of aspects across various embodiments), adaptations, and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and, accordingly, all suitable modifications and equivalents may be resorted to, falling within the scope of the disclosure.

In general, it will be apparent to one of ordinary skill in the art that some of the embodiments as described hereinabove may be implemented in many different embodiments of software, firmware, and/or hardware. For example, the embodiments described hereinabove may be implemented in computer software using any suitable computer software language. Such software may be stored on any type of suitable computer-readable medium or media, such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the present embodiments may be executed by programmable equipment, such as computers. Software that may cause programmable equipment to execute the processes may be stored in any storage device, such as, for example, a computer system (nonvolatile) memory, an optical disk, magnetic tape, or magnetic disk. Furthermore, some of the processes may be programmed when the computer system is manufactured or via a computer-readable medium. Such a medium may include any of the forms listed above with respect to storage devices as well as others. The computing systems described herein can be generally controlled and coordinated by operating system software, such as iOS, Android, Blackberry, Chrome OS, Windows XP, Windows Vista, Windows 7, Windows 8, Windows Server, Windows CE, Unix, Linux, SunOS, Solaris, VxWorks, or other compatible operating systems. In other embodiments, the computing device can be controlled by a proprietary operating system. Operating systems can control and schedule computer processes for execution, perform memory management, provide file systems, networking, I/O services, and provide a user interface functionality, such as a graphical user interface (“GUI”), among other things.

Furthermore, although aspects of the disclosed embodiments may be associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

While the disclosure has been described in detail and with reference to specific embodiments thereof, it will be apparent to one skilled in the art that various changes and modifications can be made therein without departing from the spirit of the embodiments. Thus, it is intended that the present disclosure cover the modifications and variations of this disclosure provided they come within the scope of the appended claims and their equivalents.

It is claimed:

1. One or more computer storage media storing computer-readable instructions that when executed by one or more processors, cause the one or more processors to perform operations comprising:
receiving application data associated with the origination of a lending product for a customer;
determining, based on the application data, whether a manual underwriting action is required for a decision outcome on the lending product;
assigning a first task to a first party if a manual underwriting action is determined to be required, wherein the first task includes instructions for completing a first manual underwriting action and a determination of the application data that will be displayed to complete the first manual underwriting action;
displaying, to the first party, instructions for completing the first manual underwriting action and the determined portion of the application data; and
receiving, from the first party, a task resolution that includes information associated with a first manual underwriting action.

2. The computer storage media of claim 1, further comprising:
assigning a second task that includes instructions for completing a second manual underwriting action and a determination of the application data that will be displayed to complete the second manual underwriting action.

3. The computer storage media of claim 2, wherein the determined application data that will be displayed to complete the first manual underwriting action is different from the determined application data that will be displayed to complete the second manual underwriting action.

4. The computer storage media of claim 2, wherein the second task is assigned to a second party.

5. The computer storage media of claim 4, wherein the determined application data that will be displayed to complete the first manual underwriting action is displayed to the first party at the same time that the determined application data that will be displayed to complete the second manual underwriting action is displayed to the second party.

6. The computer storage media of claim 4, wherein access to the first task is controlled such that the portion of the application data displayed to complete the first manual underwriting action is not displayed to the second party.

7. The computer storage media of claim 2, further comprising:
determining which of the first and second tasks will be prioritized for completion, wherein the tasks are controllably assigned such that a prioritized task must be completed prior to a deprioritized task.

8. The computer storage media of claim 2, wherein the application data includes information not provided by the customer.

9. The computer storage media of claim 1, further comprising:
generating a dependent task after receiving a task resolution that includes information associated with a manual underwriting action, wherein the dependent task includes instructions for completing a dependent manual underwriting action and a determination of the application data that will be displayed to complete the dependent manual underwriting action.

10. The computer storage media of claim 9, further comprising:
assigning the dependent task to a second party;
displaying, to the second party, instructions for completing the dependent manual underwriting action and the determined portion of the application data; and
receiving, from the second party, a task resolution that includes information associated with the dependent manual underwriting action.

11. The computer storage media of claim 1, further comprising:
reassigning the first task to a second party to complete the first manual underwriting action.

12. The computer storage media of claim 1, wherein the task resolution includes information on an associated task status.

13. A banking system for controlling manual underwriting actions associated with the origination of a lending product, the banking system comprising:
a datastore housing a set of underwriting task rules associated with specific underwriting tasks that will be assigned to users for completing manual underwriting actions, each underwriting task rule including:
information for determining when the task will be assigned to a party;
instructions for completing a manual underwriting action as part of the task; and
information regarding application data that will be displayed with the task;
one or more processors configured to perform operations comprising:
displaying, to a user, a visual interface depicting the set of underwriting task rules;
receiving, from the user, a request to modify the set of underwriting task rules housed in the datastore; and
modifying the set of underwriting task rules.

14. The banking system of claim 13, wherein the request to modify the set of underwriting task rules is a request to create a new underwriting task rule.

15. The banking system of claim 13, wherein the request to modify the set of underwriting task rules is provided in a low-code or no-code form.

16. The banking system of claim 13, wherein the received request is to alter one or more existing underwriting task rules.

17. The banking system of claim 13, wherein the one or more processors are further configured to perform operations comprising:
receiving application data associated with the origination of a lending product for a customer;
determining, based on application data and the set of underwriting task rules, whether a manual underwriting action is required for a decision outcome on the lending product; and
assigning a first task to a first party if a manual underwriting action is determined to be required, wherein the first task includes instructions for completing a first manual underwriting action and a determination of the application data that will be displayed to complete the first manual underwriting action.

18. The banking system of claim 13, wherein each underwriting task rule in the datastore further includes information for determining which party the task will be assigned to.

19. The banking system of claim 13, wherein the visual interface depicting the set of underwriting task rules includes a table displaying information associated with multiple tasks in a low-code or no-code form.

20. A system for controlling manual underwriting actions, the system comprising:
means for receiving application data associated with the origination of a lending product for a customer;
means for determining, based on the application data, whether a manual underwriting action is required for a decision outcome on the lending product;
means for assigning a first task to a first party if a manual underwriting action is determined to be required, wherein the first task includes instructions for completing a first manual underwriting action and a determination of the application data that will be displayed to complete the first manual underwriting action;
means for displaying, to the first party, instructions for completing the first manual underwriting action and the determined portion of the application data; and
means for receiving, from the first party, a task resolution that includes information associated with a first manual underwriting action.
